(19) United States
(12) Patent Application Publication
(10) Pub. No.: US 2026/0106363 A1
(43) Pub. Date: Apr. 16, 2026

(54) Four-port circulator

(71) Applicant: Sichuan University, Chengdu (CN)

(72) Inventors: Kama Huang, Chengdu (CN); Yi Zhang, Chengdu (CN)

(21) Appl. No.: 19/003,900

(22) Filed: Dec. 27, 2024

(30) Foreign Application Priority Data
Dec. 28, 2023 (CN) 2023118694533

(51) Int. Cl. H01P 1/39

(52) U.S. Cl. CPC H01P 1/39

(57) ABSTRACT

A four-port circulator, includes: a first port, a second port, a third port, a fourth port, a ferrite, and a microwave transmission chamber; wherein the first port, the second port, the third port, and the fourth port are symmetrically distributed around the microwave transmission chamber, and connected to the microwave transmission chamber; wherein the ferrite is horizontally provided on an upper surface or a lower surface of a center position of the microwave transmission chamber. The four-port circulator of the present invention aims to reduce the volume and cost of the four-port waveguide circulator.

### CROSS REFERENCE OF RELATED APPLICATION

The present application claims priority under 35 U.S.C. 119(a-d) to CN2023118694533, filed Dec. 28, 2023.

### BACKGROUND OF THE PRESENT INVENTION

### Field of Invention

The present invention relates the field of microwave nonreciprocal technology, and more particularly to a four-port circulator.

### Description of Related Arts

Waveguide circulator has made great progress in recent decades, and has been widely used in magnetron's injection locking, high power combining, radar, communication system, microwave materials processing, microwave drying systems. In power synthesis systems of injection magnetrons, the current widely used waveguide circulator is a four-port differential phase shift circulator (DPSC) or four ports connected by a pair of three-port junction circulators in series. But such an approach is very bulky, large in size, and the price is quite expensive, which limits their integration in industrial applications, especially in high-power applications in the future. Facing the shortcomings of heavy quality, large volume and high cost, how to achieve the miniaturization of the four-port waveguide circulator is a challenging work.

### SUMMARY OF THE PRESENT INVENTION

Based on the above problems, the preferred embodiments of the present invention provide a four-port circulator, which aims to reduce the volume and cost of the four-port waveguide circulator.

According to the preferred embodiments, the present invention provides a four-port circulator, comprising: a first port, a second port, a third port, a fourth port, a ferrite, and a microwave transmission chamber;
wherein the first port, the second port, the third port, and the fourth port are symmetrically distributed around the microwave transmission chamber, and connected to the microwave transmission chamber;
wherein the ferrite is horizontally provided on an upper surface or a lower surface of a center position of the microwave transmission chamber.

Preferably, the first port, the second port, the third port, and the fourth port are connected to an execution unit via a waveguide port, or connected to the execution unit via a coaxial port.

Preferably, when the first port, the second port, the third port, and the fourth port are connected to the execution unit via the coaxial port, the original waveguide port needs to become the terminal short circuit, and the coaxial port is located on the top, side, or end of the port.

Preferably, in the case of the ferrite comprises the first ferrite and the second ferrite, the ferrite is horizontally provided on an upper surface or a lower surface of the central position of the microwave transmission chamber, wherein:
the first ferrite is provided at an intersection of a center line of the first port and a center line of the second port on the upper surface or the lower surface of the microwave transmission chamber; and
the second ferrite is provided at an intersection of a center line of the third port and a center line of the fourth port on the upper surface or the lower surface of the microwave transmission chamber.

Preferably, in the case of the ferrite comprises a first ferrite couple and a second ferrite couple, the ferrite is horizontally provided on an upper surface or a lower surface of the central position of the microwave transmission chamber, wherein:
the first ferrite couple is provided at an intersection of a center line of the first port and a center line of the second port on the upper surface or the lower surface of the microwave transmission chamber; and
the second ferrite couple is provided at an intersection of a center line of the third port and a center line of the fourth port on the upper surface or the lower surface of the microwave transmission chamber.

Preferably, the first ferrite is a single-piece ferrite provided in the upper surface or lower surface of the microwave transmission chamber, or the first ferrite is a ferrite set provided with a preset number of ferrites on the upper surface or the lower surface in the microwave transmission chamber; and
the second ferrite is a single-piece ferrite provided in the upper surface or lower surface of the microwave transmission chamber, or the second ferrite is a ferrite set provided with a preset number of ferrites on the upper surface or the lower surface in the microwave transmission chamber.

Preferably, in the case of the ferrite comprises the first ferrite column and the second ferrite column, the ferrite is horizontally provided on an upper surface or a lower surface of the central position of the microwave transmission chamber, wherein:
the first ferrite column is provided at an intersection of a center line of the first port and a center line of the second port and connected with the upper surface and the lower surface of the microwave transmission chamber; or connected with the upper surface of the microwave transmission chamber; or connected with the lower surface of the microwave transmission chamber; and
the second ferrite column is provided at an intersection of a center line of the third port and a center line of the fourth port and connected with the upper surface and the lower surface of the microwave transmission chamber; or connected with the upper surface of the microwave transmission chamber; or connected with the lower surface of the microwave transmission chamber.

Preferably, in the case of the ferrite comprises the first ferrite and the second ferrite, or comprises the first ferrite column and the second ferrite column, the four-port circulator further comprises a stub;
wherein the stub is provided at the center of the microwave transmission chamber, connected to the upper surface of the microwave transmission chamber, or is connected to the lower surface of the microwave transmission chamber.

Preferably, a shape of the stub is a cylinder, an oval column, or a rectangular column.

Preferably, the upper surface and the lower surface inside the microwave transmission chamber comprises a first convex platform protruding toward an interior of the microwave transmission chamber, and a second convex platform provided on the first convex platform.

These and other objectives, features, and advantages of the present invention will become apparent from the following detailed description, the accompanying drawings, and the appended claims.

### BRIEF DESCRIPTION OF THE DRAWINGS

In order to explain the technical solution of the embodiment of this application more clearly, the following will be briefly introduced in the description of the implementation examples of this application. For ordinary technical personnel in the art, under the premise of not paying creative labor, you can also obtain other attached pictures based on these attached pictures.

FIG. 1 is a schematic diagram of a four-port circulator according to a preferred embodiment of the present invention.

FIG. 2 is a schematic diagram showing application scenario of the four-port circulator according to the preferred embodiment of the present invention.

FIG. 3 is a first schematic diagram showing coaxial port settings in the four-port circulator according to the preferred embodiment of the present invention.

FIG. 4 is a second schematic diagram of the four-port circulator with a stub according to the preferred embodiment of the present invention.

FIG. 5 is a schematic diagram of the four-port circulator with the stub according to the preferred embodiment of the present invention.

FIG. 6 is another schematic diagram of the four-port circulator according to the preferred embodiment of the present invention.

### NUMBERS OF ELEMENTS IN THE DRAWINGS

1—first port; 2—second port; 3—third port; 4—fourth port; 5—ferrite; 6—microwave transmission chamber; 7—first convex; 8—second convex; 9—external end surface of the ports; 10—stub; 11—magnet; 12—water circulation; 51—first ferrite; 52—second ferrite; 53—first ferrite column; 54—second ferrite column.

### DETAILED DESCRIPTION OF THE PREFERRED EMBODIMENT

Below the attached figures in the embodiments of this application will be clearly and fully described in the technical solution in the embodiments of this application. Obviously, the embodiment described is a part of the implementation example of this application, not all embodiments. Based on the embodiments in this application, all other embodiments obtained by ordinary technical personnel in the art under the premise of not creative labor belong to the scope of this application protection.

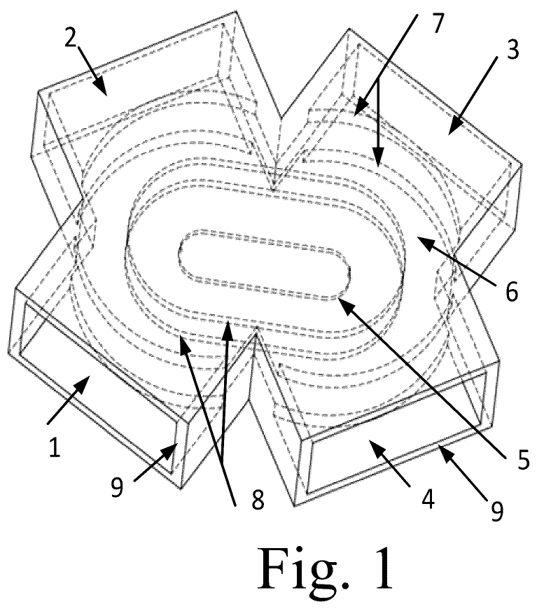

In order to overcome the problems existing in related technologies, this application provides a four-port circulator. FIG. 1 is a schematic diagram of a four-port circulator according to a preferred embodiment of the present invention. Referring to FIG. 1, the four-port circulator of the present invention comprises: a first port, a second port, a third port, a fourth port, a ferrite, and a microwave transmission chamber;

wherein the first port, the second port, the third port, and the fourth port are symmetrically distributed around the microwave transmission chamber, and connected to the microwave transmission chamber;

wherein the ferrite is horizontally provided on an upper surface or a lower surface of a center position of the microwave transmission chamber.

In this embodiment, as shown in FIG. 1, the four-port circulator in this application comprises a hollow microwave transmission chamber 6. The first port 1, the second port 2, the third port 3, and the fourth port 4 are symmetrically connected with the microwave transmission chamber 6. The ferrite 5 is distributed in the upper surface or the lower surface of the microwave transmission chamber 6. FIG. 1 shows that the ferrite 5 is horizontally provided at the center of the microwave transmission chamber 6 and connected to the lower surface of the microwave transmission chamber 6.

In another embodiment, the ferrite 5 can also be couple ferrites, which are distributed on the upper and lower surfaces of the interior of the microwave transmission chamber 6. When the ferrite 5 is a ferrite couple, one ferrite in the ferrite couple is horizontally provided in the center position of the microwave transmission chamber 6. The one ferrite is connected to the upper surface of the microwave transmission chamber 6, the other ferrite in the ferrite couple is horizontally provided in the microwave transmission chamber 6, and the other ferrite is connected to the lower surface of the microwave transmission chamber 6. The two ferrites are symmetrically distributed on the upper and lower surfaces of the microwave transmission chamber 6.

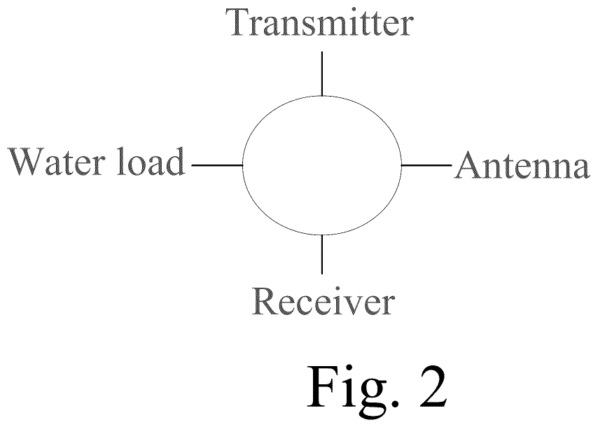

In this embodiment, the four-port circulator in this application can be applied in various microwave and millimeter wave receiving systems, which are explained by two specific embodiments. A specific application scenario is: the four ports are connected to the injection signal source, the magnetron, the processing unit, and the load, such as the first port 1 connect to the signal source, the second port 2 connects the magnetron, the third port 3 connects the processing unit and the fourth port 4 connects the load. The injection signal source is used to inject control signals to control the microwave of the corresponding energy size of the magnetron of the second port 2, and then the input microwave will be transmitted to the third port 3 for the processing unit on the third port 3. The third port 3 can use the received microwave for heating and drying applications The fourth port 4 connecting the load is configured to absorb microwave energy reflected by the processing unit, so as to prevent the microwave energy reflected from damage the injected signal source connected on the first port 1, for instance, a water load is connected with the fourth port 4. Another specific application scenario is: as shown in FIG. 2, the four ports are connected to the transmitter, antenna, receiver, and load in turn, such as the first port 1 connects the transmitter, the second port 2 connects the antenna, the third port 3 connects the receiver and the fourth port 4 connects the water load. The transmitter of the first port 1 is used to output microwave signals, the signals are transmitted to an antenna of the second port 2 by a one-way transmission, and then sent to a space via the antenna of the second port 2. Meanwhile, the antenna of the second port 2 is further configured to receive microwave signals from the space, and transmit the microwave signals in one way to a receiver of the third port 3, and the load of the fourth port 4 is configured to absorb the microwave energy reflected by the receiver, and a water load is provided on the fourth port 4.

In this application, the upper surface and the lower surface inside the microwave transmission chamber comprises a first convex platform protruding toward an interior of the microwave transmission chamber, and a second convex platform provided on the first convex platform.

In this embodiment, as shown in FIG. 1, in order to improve the port matching effect of the microwave in the microwave transmission chamber 6, that is, the microwave inputted on each port is capable of entering the microwave transmission chamber 6 and having lower microwave reflection, the upper surface of this hollow microwave transmission chamber 6 has a protruding first convex platform 7 inside the microwave transmission chamber 6, and the lower surface of the hollow microwave transmission chamber 6 has a first convex platform 7 protruding toward the interior of the microwave transmission chamber 6. Meanwhile, the surface of the first convex platform 7 on the upper surface has a second convex platform 8 which is concentric with the first convex platform 7 and protrudes toward the inside of the microwave transmission chamber 6, and the surface of the first boss 7 on the lower surface has a second convex platform 8 which is concentric with first convex platform 7 and protrudes toward the inside of the microwave transmission chamber 6. Meanwhile, one ferrite of the couple ferrites is horizontally provided in the center position of second convex platform 8 on an upper surface inside the microwave transmission chamber 6, meanwhile, the other ferrite of the couple ferrites is horizontally provided in the center position of the second convex platform 8 on a lower surface inside the microwave transmission chamber 6.

In this application, the first port, the second port, the third port, and the fourth port are connected to the execution unit via the coaxial port, the original waveguide port needs to become the terminal short circuit, and the coaxial port can be located on the top, side, or end of the port.

In this embodiment, the four ports in the four-port circulator can set the specific connection method to the execution unit according to the microwave energy transmitted in the actual application scenario, such as the waveguide port and the coaxial port. When the microwave energy transmitted in the actual application scenario is large, the four ports can be connected to the execution unit in the form of the waveguide port. As shown in FIG. 1, each port shown in the FIG. 1 is a hollow structure. At this time, the connection method of each port to the execution unit is to connect through the waveguide port. Among them, the execution unit comprises but is not limited to the injection signal source, the magnetron, antenna, microwave signal transmitter, microwave signal receiver, and water load. When the microwave energy transmitted in the actual application scenario is small, and the four ports can be connected to the execution unit in the form of a coaxial port. As shown in FIG. 1, when the four ports are connected to each execution unit with the coaxial port, the external end surface 9 of the 4 ports shown in FIG. 1 is in a closed state, and then at any end surface on the end of the four ports. A coaxial port is provided on a hole opened on any end surface on the four ports, so that the execution unit is connected to the four ports of the four-port circulator in a manner of the coaxial port.

In this application, when the port is connected to the execution unit through the coaxial port, the position of the coaxial port is located on the top of the port, or on the bottom of the port, or on the side surface of the port, or located on an end surface of the port.

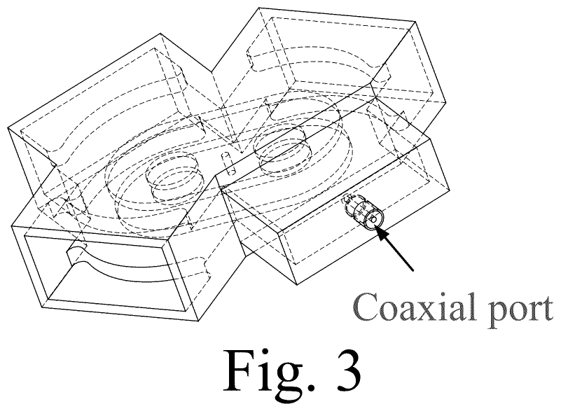

In this embodiment, in the case where the four ports are connected to respective corresponding execution units in the form of coaxial ports, the coaxial ports are provided at a location that may be located on the upper surface of the port, or on the lower surface of the port, or on the left or right sides of the port, or on the end surface of the port. As shown in FIG. 3, FIG. 3 illustrates a schematic diagram of a coaxial port provided at an end surface of a port.

In the present application, in the case of the ferrite comprises the first ferrite and the second ferrite, the ferrite is horizontally provided on an upper surface or a lower surface of the central position of the microwave transmission chamber, wherein:
the first ferrite is provided at an intersection of a center line of the first port and a center line of the second port on the upper surface or the lower surface of the microwave transmission chamber; and
the second ferrite is provided at an intersection of a center line of the third port and a center line of the fourth port 4 on the upper surface or the lower surface of the microwave transmission chamber.

In the present application, in the case of the ferrite comprises a first ferrite couple and a second ferrite couple, the ferrite is horizontally provided on an upper surface or a lower surface of the central position of the microwave transmission chamber, wherein:
the first ferrite couple is provided at an intersection of a center line of the first port and a center line of the second port on the upper surface or the lower surface of the microwave transmission chamber; and
the second ferrite couple is provided at an intersection of a center line of the third port and a center line of the fourth port 4 on the upper surface or the lower surface of the microwave transmission chamber.

In the present application, the first ferrite is a single-piece ferrite provided in the upper surface or lower surface of the microwave transmission chamber, or the first ferrite is a ferrite set provided with a preset number of ferrites on the upper surface or the lower surface in the microwave transmission chamber; and
the second ferrite is a single-piece ferrite provided in the upper surface or lower surface of the microwave transmission chamber, or the second ferrite is a ferrite set provided with a preset number of ferrites on the upper surface or the lower surface in the microwave transmission chamber.

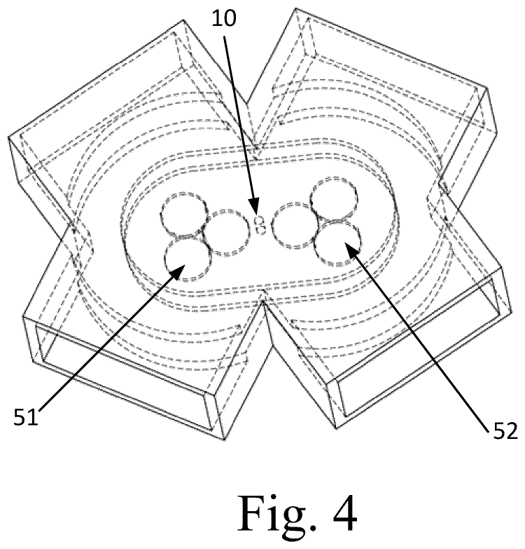

In this embodiment, as shown in FIG. 4, the other embodiment of the ferrite 5 in the four-port circulator provided by this application is the ferrite 5 comprising the first ferrite 51 and the second ferrite 52.

When the ferrite 5 comprises a first ferrite 51 and a second ferrite 52, the first ferrite 51 is provided at the intersection of the center line of the first port 1 and the center line of the second port 2 on an upper surface or a lower surface in the microwave transmission chamber 6. FIG. 4 shows the first ferrite 51 is provided at the intersection of the center line of the first port 1 and the center line of the second port 2 on a lower surface in the microwave transmission chamber 6. In another embodiment, the first ferrite 51 can also be a first ferrite couple, which are respectively arranged at the intersection of the center line of the first port 1 and the center line of the second port 2 on the upper and lower surfaces in the microwave transmission chamber 6. When the first ferrite 51 is a first ferrite couple, a part of the ferrite in the first ferrite couple is arranged at the intersection of the center line of the first port 1 and the center line of the second port 2 on the lower surface in the microwave transmission chamber 6, and the other part of the first ferrite in the first ferrite pair is arranged at the intersection of the center line of the first port 1 and the center line of the second port 2 on the upper surface in the microwave transmission chamber 6. The two parts of the ferrite are symmetrically distributed at the intersection of the center line of the first port 1 and the center line of the second port 2 on the upper and lower surfaces in the microwave transmission chamber 6.

In this embodiment, the first ferrite 51 provided at the intersection of the center line of the first port 1 and the center line of the second port 2 on the upper surface or the lower surface of the microwave transmission chamber 6 can be a single ferrite or a preset number of ferrites. As shown in FIG. 4, the first ferrite 51 is shown as three ferrites disposed on the lower surface of the microwave transmission chamber 6 at the intersection of the center line of the first port 1 and the center line of the second port 2. When the first ferrite 51 can be a first ferrite couple, the number of ferrites in the two parts of the upper and lower surfaces of the microwave transmission chamber 6 respectively distributed at the intersection of the center line of the first port 1 and the center line of the second port 2 is identical. For example, if the number of ferrites in one part of the first ferrite couple arranged at the intersection of the center line of the first port 1 and the center line of the second port 2 on the upper surface of the microwave transmission chamber 6 is 3 pieces, then the number of ferrites in the other part of the first ferrite couple arranged at the intersection of the center line of the first port 1 and the center line of the second port 2 on the lower surface of the microwave transmission chamber 6 is also 3 pieces. At the same time, the two parts are symmetrically distributed on the upper and lower surfaces of the microwave transmission chamber 6 at the intersection of the center line of the first port 1 and the center line of the second port 2. The shape of each piece of ferrite can be circular, triangular or polygonal, which is not specifically limited here.

In this embodiment, the second ferrite 52 provided at the intersection of the center line of the third port 3 and the center line of the fourth port 4 on the upper surface or the lower surface of the microwave transmission chamber 6. As shown in FIG. 4, the second ferrite 52 is disposed on the lower surface of the microwave transmission chamber 6 at the intersection of the center line of the third port 3 and the center line of the fourth port 4. According to another preferred embodiment of the present invention, when the second ferrite 52 can be a second ferrite couple, respectively arranged at the intersection of the center line of the third port 3 and the center line of the fourth port 4 on the upper and lower surfaces of the microwave transmission chamber 6. When the second ferrite 52 is a second ferrite couple, a part of the ferrite in the second ferrite couple is arranged on the lower surface of the microwave transmission chamber 6 at the intersection of the center line of the third port 3 and the center line of the fourth port 4, and the other part of the second ferrite in the second ferrite couple is arranged on the upper surface of the microwave transmission chamber 6 at the intersection of the center line of the third port 3 and the center line of the fourth port 4. The two parts of the ferrite are symmetrically distributed on the upper and lower surfaces in the microwave transmission chamber 6 at the intersection of the center line of the third port 3 and the center line of the fourth port 4.

In this embodiment, the second ferrite 52 disposed on the upper surface or the lower surface of the microwave transmission chamber 6 at the intersection of the center line of the third port 3 and the center line of the fourth port 4 can be a single ferrite or a preset number of ferrites. As shown in FIG. 4, the second ferrite 52 is shown as three ferrites disposed on the lower surface of the microwave transmission chamber 6 at the intersection of the center line of the third port 3 and the center line of the fourth port 4. When the second ferrite 52 can be a second ferrite couple, the number of ferrites provided on the upper surface of the microwave transmission chamber 6 at the intersection of the center line of the third port 3 and the center line of the fourth port 4 is identical with the number of ferrites provided on the lower surface thereof. For example, if the number of ferrites in one part of the second ferrite couple arranged on the upper surface of the microwave transmission chamber 6 at the intersection of the center line of the third port 3 and the center line of the fourth port 4 is 3 pieces, and the number of ferrites in the other part of the second ferrite couple arranged on the lower surface of the microwave transmission chamber 6 at the intersection of the center line of the third port 3 and the center line of the fourth port 4 is also 3 pieces. At the same time, the two parts are symmetrically distributed on the upper and lower surfaces of the microwave transmission chamber 6 at the intersection of the center line of the third port 3 and the center line of the fourth port 4. The shape of each piece of ferrite can be circular, triangular or polygonal, which is not specifically limited here.

In this embodiment, when the first ferrite 51 is a first ferrite couple, and the second ferrite 52 is a second ferrite couple, the number of the first ferrite couple and the second ferrite couple can be different. For example, the number of ferrites in a part of the first ferrite couple provided on the upper surface of the microwave transmission chamber 6 at the intersection of the center line of the first port 1 and the center line of the second port 2 is 3 pieces; the number of ferrites in the other part of the first ferrite couple provided on the lower surface of the microwave transmission chamber 6 at the intersection of the center line of the first port 1 and the center line of the second port 2 is 3 pieces; the number of ferrites in a part of the second ferrite couple provided on the upper surface of the microwave transmission chamber 6 at the intersection of the center line of the third port 3 and the center line of the fourth port 4 is 1 piece; the number of ferrites in the other part of the second ferrite couple provided on the lower surface of the microwave transmission chamber 6 at the intersection of the center line of the third port 3 and the center line of the fourth port 4 is 1 piece as well.

In this application, in the case of the ferrite comprises the first ferrite column and the second ferrite column, the ferrite is horizontally provided on an upper surface or a lower surface of the central position of the microwave transmission chamber, wherein: the first ferrite column is provided at an intersection of a center line of the first port and a center line of the second port and connected with the upper surface and the lower surface of the microwave transmission chamber; or connected with the upper surface of the microwave transmission chamber; or connected with the lower surface of the microwave transmission chamber; and the second ferrite column is provided at an intersection of a center line of the third port and a center line of the fourth port 4 and connected with the upper surface and the lower surface of the microwave transmission chamber; or connected with the upper surface of the microwave transmission chamber; or connected with the lower surface of the microwave transmission chamber.

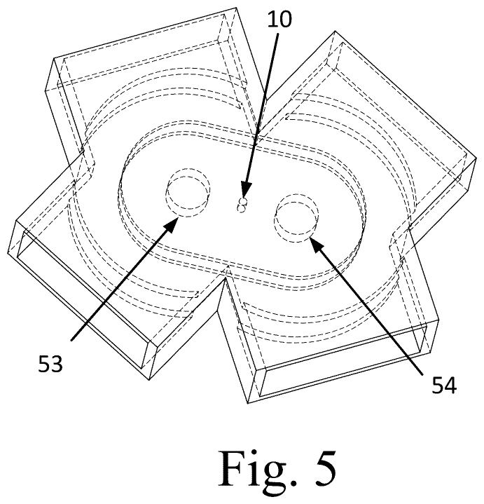

In this embodiment, as shown in FIG. 5, the other embodiment of the ferrite in the four-port circulator in this application is that the ferrite 5 comprises the first ferrite column 53 and the second ferrite column 54.

When the ferrite 5 comprises the first ferrite column 53 and the second ferrite column 54, the first ferrite column 53 is arranged in the microwave transmission chamber 6 at the intersection of the center line of the first port 1 and the center line of the second port 2, and is connected to the upper and lower surfaces of the microwave transmission chamber 6, and can also be connected to only one of the upper and lower surfaces of the microwave transmission chamber 6. The second ferrite column 54 is arranged in the microwave transmission chamber 6 at the intersection of the center line of the third port 3 and the center line of the fourth port 4, and is connected to the upper and lower surfaces of the microwave transmission chamber 6, and can also be connected to only one of the upper and lower surfaces of the microwave transmission chamber 6.

In the present application, in the case of the ferrite comprises the first ferrite and the second ferrite, or comprises the first ferrite column and the second ferrite column, the four-port circulator further comprises a stub; wherein the stub is provided at the center of the microwave transmission chamber, connected to the upper surface of the microwave transmission chamber, or is connected to the lower surface of the microwave transmission chamber.

In this embodiment, as shown in FIG. 4 and FIG. 5, when one embodiment of the ferrite 5 comprises a first ferrite 51 and a second ferrite 52, or one embodiment of the ferrite 5 comprises a first ferrite column 53 and a second ferrite column 54, the four-port circulator provided in this application further comprises a stub 10, which is arranged at the center of the microwave transmission chamber 6 and connected to the upper surface of the microwave transmission chamber 6, or connected to the lower surface of the microwave transmission chamber 6.

In the present application, a shape of the stub is a cylinder, an oval column, or a rectangular column.

In this embodiment, the stub 10 provided in the four-port circulator can be in a shape of a cylinder, an oval column, or a rectangular column, and can also be other column shapes, which are not specifically limited here.

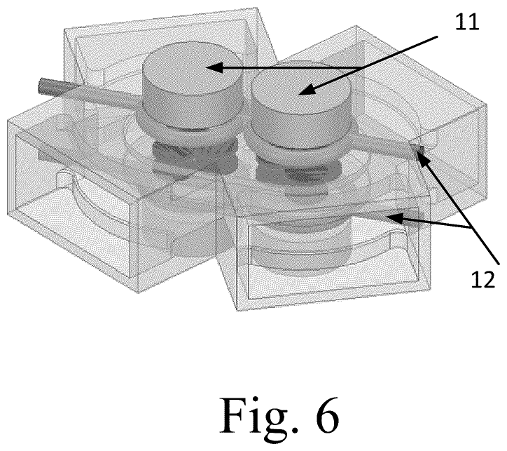

In this embodiment, the purpose of setting ferrite 5 is to achieve non-reciprocal transmission in the microwave transmission chamber 6, that is, one-way transmission, and in order to achieve the object that the ferrite 5 capable of processing non-reciprocal transmission on the microwaves in the microwave transmission chamber 6, the upper and lower surfaces of the four-ends need to set a bias magnetic field at the upper and lower surface of the four ports. For example, a magnet 11 is provided to form a bias magnetic field. The purpose of non-reciprocal transmission is performed. Refer to FIG. 6, which is a schematic diagram of the location of the magnetic 11 setting. A first group of two magnets 11 are provided on an upper surface on the four-port circulator, which is opposite to the ferrite; and a second group of two magnets 11 are provided on a lower surface on the four-port circulator, which is opposite to the ferrite. It should be understood that this is just a signature to show the location relationship between magnet 11 and the ferrite 5, and it is not used as a limitation of this application. Similarly, a larger magnet 11 can be set on the upper surface of the four-port circulator to cover the ferrite set on the upper surface inside the microwave transmission chamber 6, and a larger magnet 11 can be set on the lower surface of the four-port circulator to cover the ferrite set on the lower surface inside the microwave transmission chamber 6, without specific limitation here.

In this embodiment, in order to ensure the long-term normal operation of the four-port circulator, as shown in FIG. 6, the present application constructs a water circuit 12 between the magnet 11 and the ferrite inside the shell of the four-port circulator to cool the ferrite and the magnet 11 during operation to ensure the long-term normal operation of the four-port circulator. Refer to FIG. 6, which is only an exemplary description of the water circuit 12 constructed between the magnet 11 and the ferrite, and is not intended to limit the present application. The water circuit 12 constructed between the magnet 11 and the ferrite can also be a water circuit 12 with other structures, which is not specifically limited here.

In the embodiments of the present invention, the circulator is required to has good performance for transmitting along a one-way direction, and transmitting along an opposite direction is prevented. The ferrite 5 is embodied as the first ferrite 51 and the second ferrite 52, or the ferrite 5 is embodied as the first ferrite column 53 and the second ferrite column 54, during the transmission process from the second port 2 to third port 3, some microwaves return back to the first port 1, making the isolation performance of the four-port circulator not good enough. In order to ensure that the four-port circulator provided by the present invention has high isolation characteristics in practical applications, when the ferrite 5 is embodied as the first ferrite 51 and the second ferrite 52, the present application sets a stub 10 on the upper surface of the microwave transmission chamber 6 at the midpoint of the center line connecting the first ferrite 51 and the second ferrite 52, or sets a stub 10 on the lower surface of the microwave transmission chamber 6 at the midpoint of the center line connecting the first ferrite 51 and the second ferrite 52, that is, the stub 10 is connected to one of the upper surface or the lower surface in the microwave transmission chamber 6. When the ferrite 5 is embodied as the first ferrite column 53 and the second ferrite column 54, the present application sets a stub 10 on the upper surface of the microwave transmission chamber 6 at the midpoint of the center line connecting the first ferrite column 53 and the second ferrite column 54, or sets a stub 10 on the lower surface of the microwave transmission chamber 6 at the midpoint of the center line connecting the first ferrite column 53 and the second ferrite column 54, that is, the stub 10 is connected to one of the upper surface or the lower surface in the microwave transmission chamber 6. The stub 10 can be formed integrally with the surface of the microwave transmission chamber 6, or can be installed after the microwave transmission chamber 6 is processed, which is not specifically limited here. In addition, the stub 10 is made of metal.

The embodiments in this manual are described in a progressive way. Each embodiment focuses on the difference between other embodiments, and the same similar parts of each embodiment can be referred to each other.

Although it has described the preferred embodiments of the embodiments of the present invention, once the technicians in the field learned the basic creative concepts, they could make another change and modification of these embodiments. Therefore, the attached claim intends to interpret all the changes and modifications comprising preferred embodiments and all the scope of the scope of the implementation of the present invention. In the end, it is also necessary to explain that in this article, the relationships such as the first and second-class term are only used to distinguish one entity or operation from the other entity or operation, not necessarily required or implied these entities or there are any such actual relationships or sequences between operations. Moreover, the term “comprises”, “comprise” or any other variants that covers non-exclusive contains, so that the processes, methods, items, or terminal equipment including a series of elements comprise not only those elements, but also without a clear column. Other elements, or the elements inherent in this process, methods, items, or terminal equipment. In the absence of more restrictions, the limited element that “comprises one . . . ” does not rule out that there are still the same elements in the processes, methods, items, or terminal equipment comprising the elements.

The above-mentioned four-port circulator shaped parts provided by the present invention have been introduced in detail. This article uses specific examples to explain the principles and embodiments of the invention. The description of the above embodiments is only used to help understand the method of the present invention. And its core ideas; at the same time, for the general technical personnel in the art, according to the ideas of the present invention, there will be changes in the specific implementation methods and application scope. In summary, the content of this manual should not be understood as the present invention.

What is claimed is:

1. A four-port circulator, comprising: a first port, a second port, a third port, a fourth port, a ferrite, and a microwave transmission chamber;
wherein the first port, the second port, the third port, and the fourth port are symmetrically distributed around the microwave transmission chamber, and connected to the microwave transmission chamber;
wherein the ferrite is horizontally provided on an upper surface or a lower surface of a center position of the microwave transmission chamber.

2. The four-port circulator, as recited in claim 1, wherein the first port, the second port, the third port, and the fourth port are connected to an execution unit via a waveguide port, or connected to the execution unit via a coaxial port.

3. The four-port circulator, as recited in claim 2, wherein when the first port, the second port, the third port, and the fourth port are connected to the execution unit via the coaxial port, the original waveguide port needs to become the terminal short circuit, and the coaxial port is located on the top, side, or end of the port.

4. The four-port circulator, as recited in claim 1, wherein in the case of the ferrite comprises the first ferrite and the second ferrite, the ferrite is horizontally provided on an upper surface or a lower surface of the central position of the microwave transmission chamber, wherein:
the first ferrite is provided at an intersection of a center line of the first port and a center line of the second port on the upper surface or the lower surface of the microwave transmission chamber; and
the second ferrite is provided at an intersection of a center line of the third port and a center line of the fourth port on the upper surface or the lower surface of the microwave transmission chamber.

5. The four-port circulator, as recited in claim 1, wherein in the case of the ferrite comprises a first ferrite couple and a second ferrite couple, the ferrite is horizontally provided on an upper surface or a lower surface of the central position of the microwave transmission chamber, wherein:
the first ferrite couple is provided at an intersection of a center line of the first port and a center line of the second port on the upper surface or the lower surface of the microwave transmission chamber; and
the second ferrite couple is provided at an intersection of a center line of the third port and a center line of the fourth port on the upper surface or the lower surface of the microwave transmission chamber.

6. The four-port circulator, as recited in claim 4, wherein the first ferrite is a single-piece ferrite provided in the upper surface or lower surface of the microwave transmission chamber, or the first ferrite is a ferrite set provided with a preset number of ferrites on the upper surface or the lower surface in the microwave transmission chamber; and
the second ferrite is a single-piece ferrite provided in the upper surface or lower surface of the microwave transmission chamber, or the second ferrite is a ferrite set provided with a preset number of ferrites on the upper surface or the lower surface in the microwave transmission chamber.

7. The four-port circulator, as recited in claim 6, wherein in the case of the ferrite comprises the first ferrite column and the second ferrite column, the ferrite is horizontally provided on an upper surface or a lower surface of the central position of the microwave transmission chamber, wherein:
the first ferrite column is provided at an intersection of a center line of the first port and a center line of the second port and connected with the upper surface and the lower surface of the microwave transmission chamber; or connected with the upper surface of the microwave transmission chamber; or connected with the lower surface of the microwave transmission chamber; and
the second ferrite column is provided at an intersection of a center line of the third port and a center line of the fourth port and connected with the upper surface and the lower surface of the microwave transmission chamber; or connected with the upper surface of the microwave transmission chamber; or connected with the lower surface of the microwave transmission chamber.

8. The four-port circulator, as recited in claim 7, wherein in the case of the ferrite comprises the first ferrite and the second ferrite, or comprises the first ferrite column and the second ferrite column, the four-port circulator further comprises a stub;
wherein the stub is provided at the center of the microwave transmission chamber, connected to the upper surface of the microwave transmission chamber, or is connected to the lower surface of the microwave transmission chamber.

9. The four-port circulator, as recited in claim 8, wherein a shape of the stub is a cylinder, an oval column, or a rectangular column.

10. The four-port circulator, as recited in claim 1, wherein the upper surface and the lower surface inside the microwave transmission chamber comprises a first convex platform protruding toward an interior of the microwave transmission chamber, and a second convex platform provided on the first convex platform.
